(19) United States
(12) Patent Application Publication
(10) Pub. No.: US 2019/0020197 A1
(43) Pub. Date: Jan. 17, 2019

(54) METHOD AND SYSTEM FOR MANAGING CHARGING/DISCHARGING OF ELECTRIC ENERGY BASED ON PREDICTION FOR PHOTOVOLTAIC POWER AND LOAD

(71) Applicant: OCI COMPANY LTD., Seoul (KR)

(72) Inventors: Cha Ho AHN, Seongnam-si (KR); Young Il KIM, Seongnam-si (KR); Jin Sun YANG, Seongnam-si (KR); Woo Young CHOI, Seongnam-si (KR)

(21) Appl. No.: 15/699,475

(22) Filed: Sep. 8, 2017

(30) Foreign Application Priority Data
Jul. 12, 2017 (KR) 10-2017-0088642

(51) Int. Cl. H02J 3/38; H02J 7/35; H02J 7/00; H02J 3/00

(52) U.S. Cl. CPC H02J 3/383; H02J 7/35; H02J 2003/007; H02J 3/008; H02J 2003/003; H02J 7/0068

(57) ABSTRACT

Disclosed herein is a system for managing charging/discharging of electric energy based on prediction for PV power and load. The system includes a power generation unit configured to generate electric energy from PV power, a energy storage unit configured to be charged with the electric energy supplied from the power generation unit and electric energy supplied from an external power supplier via one common node or to be discharged with the electric energy to a load via the one common node, and a manager control unit configured to predict a PV power and a load and schedule and control charging/discharging of the energy storage unit based on data of a result of the prediction.

### CROSS-REFERENCE TO RELATED APPLICATIONS

This application claims the priority of Korean Patent Application No. 10-2017-0088642 filed on Jul. 12, 2017, in the Korean Intellectual Property Office, the disclosure of which is hereby incorporated by reference in its entirety.

### BACKGROUND

### 1. Technical Field

The present disclosure relates to a method and system for managing charging/discharging of electric energy, which is capable of efficiently controlling and managing the amount of photovoltaic power (PV power) stored in an energy storage device, the amount of power supplied from the energy storage device to a load, the amount of power supplied from an external power source, and so on, based on a result of correct prediction for PV power and load, thereby improving stability and economic feasibility.

### 2. Description of the Related Art

The value of electric energy is getting higher because of depletion of energy resources and environmental destruction. Accordingly, the necessity and importance of an energy storage system that supports the storage of electric energy and the efficient utilization of stored electric energy are being emphasized.

In recent years, distributed energy resources combining renewable energy such as sunlight, energy storage devices, electric vehicles and intelligent loads have been developed. As a result, a demand for change in an energy management system through an established electric power system to which a centralized operation mechanism is applied is gradually increasing.

### SUMMARY

It is an object of the present disclosure to provide a method and system for managing charging/discharging of electric energy, which is capable of efficiently controlling and managing the amount of PV energy stored in an energy storage device, the amount of energy supplied from the energy storage device to a load, the amount of energy supplied from an external power source, and so on, based on a result of correct prediction for PV power and load, in order to increase the power utilization based on energy storage device and renewable energy, thereby improving stability and economic feasibility.

Objects of the present disclosure are not limited to the above-described objects and other objects and advantages can be appreciated by those skilled in the art from the following descriptions. Further, it will be easily appreciated that the objects and advantages of the present disclosure can be practiced by means recited in the appended claims and a combination thereof.

In accordance with one aspect of the present disclosure, there is provided a system for managing charging/discharging of electric energy based on prediction for PV power and load, including: a power generation unit configured to generate electric energy from PV power; the energy storage unit configured to be charged with the electric energy supplied from the power generation unit and electric energy supplied from an external power supplier via one common node or to be discharged with the electric energy to a load via the one common node; and a manager control unit configured to predict a PV power and a load and schedule and control charging/discharging of the energy storage unit based on data of a result of the prediction.

The system for managing charging/discharging of electric energy based on prediction for PV power and load can more correctly predict the PV power and the load. In addition, it is possible to efficiently control and manage the amount of PV power stored in an energy storage device, the amount of power supplied from the energy storage device to a load, the amount of power supplied from an external power source, and so on, based on a result of the prediction.

### BRIEF DESCRIPTION OF DRAWINGS

FIG. 1 is a view illustrating the detailed configuration of a system for managing charging/discharging of electric energy based on prediction for PV power and load, according to an embodiment of the present disclosure.

FIG. 2 is a view illustrating the detailed configuration of a manager control unit shown in FIG. 1.

FIG. 3 is a view for explaining a method for predicting PV power by a PV power predicting part shown in FIG. 2.

FIG. 4 is a view for explaining a method for predicting the load by a load predicting part shown in FIG. 2.

FIG. 5 is a view illustrating the detailed configuration of a charging/discharging setting part shown in FIG. 2.

FIG. 6 is a graph illustrating a result of prediction for PV power and load, and a corresponding battery usage.

FIG. 7 is a graph illustrating a change in PV energy price with grid side energy supplying.

FIG. 8 is a graph illustrating a change in battery state of charge which is controlled so as to obtain a profit margin according to a change in PV power/load and power trading cost.

FIG. 9 is a graph illustrating a change in battery output power which is controlled load to secure optimal operation condition with maximizing self-consumption of PV energy.

### DETAILED DESCRIPTION

The above objects, features and advantages will become apparent from the detailed description with reference to the accompanying drawings. Embodiments are described in sufficient detail to enable those skilled in the art in the art to easily practice the technical idea of the present disclosure. Detailed descriptions of well known functions or configurations may be omitted in order not to unnecessarily obscure the gist of the present disclosure. Hereinafter, embodiments of the present disclosure will be described in detail with reference to the accompanying drawings. Throughout the drawings, like reference numerals refer to like elements.

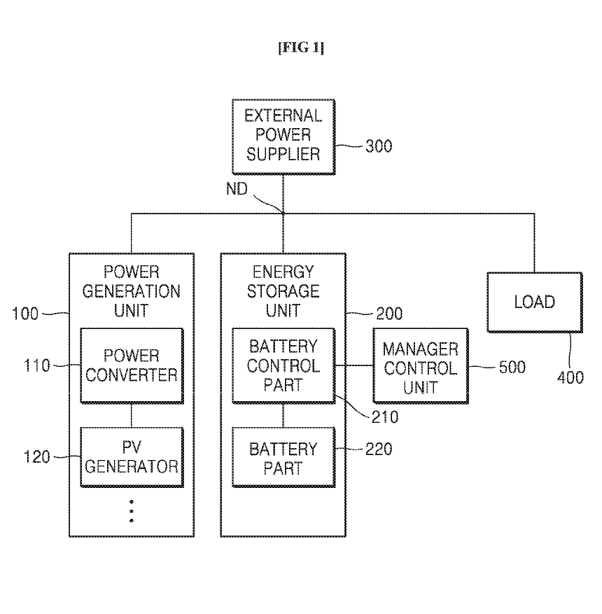

FIG. 1 is a view illustrating the detailed configuration of a system for managing charging/discharging of electric energy based on prediction for PV power and load, according to an embodiment of the present disclosure.

The electric energy charging/discharging managing system illustrated in FIG. 1 includes a power generation unit 100 for generating electric energy using PV power, a energy storage unit 200 which is charged with the electric energy from the power generation unit 100 or electric energy from an external power supplier 300, both of which are supplied via one common node (ND) or contact point, and is discharged with the electric energy to a load 400 via the common node (ND), and a manager control unit 500 for predicting the PV power, the load, scheduling and controlling the charging/discharging of the energy storage unit 200 based on data of a result of the prediction.

The power generation unit 100 includes at least one PV generator 120 to generate electric energy with PV power and a power converter 110 such as an inverter to convert the electric energy, i.e., a direct current (DC), generated by the PV generator 120 into an alternating current (AC).

The PV generator 120 is composed of a plurality of PV panels which generate electric energy. The power converter 110 such as an inverter converts power in the form of a DC source into an AC source which is then transmitted to the common node (or common contact point) ND. Thus, the PV generator 120 of the power generation unit 100 can generate renewable energy to be provided to the common node ND.

The energy storage unit 200 includes a battery part 220 and a battery control part 210. The battery part 220 is charged with the electric energy from the power generation unit 100 and the external power supplier 300 according to a charging/discharging control signal from the manager control unit 500 or is discharged with the electric energy to the load 400 or the external power supplier 300.

Specifically, upon receiving a charging control signal from the manager control unit 500, the battery control part 210 of the energy storage unit 200 charges the battery part 220 with the electric energy input from the power generation unit 100 or the external power supplier 300 via the common node ND. At this time, the battery control part 210 charges the battery part 220 with electric energy other than the demand for the load 400 among the input electric energy.

On the other hand, upon a discharging control signal from the manager control unit 500, the battery control part 210 discharges the battery part 220 with the electric energy to the common node ND so that the electric energy of the battery part 220 is supplied to the external power supplier 300 or the load 400.

The external power supplier 300 may be a power exchange centre, a power management organization or a power grid supervising agency that distributes and supplies power of a power plant. The external power supplier 300 transmits the electric energy to the common node ND for energy sale, while receiving power from the common node ND for purchase of electric energy.

The manager control unit 500 predicts the amount of PV power during a preset period using a Gaussian process method, based on the past PV power data. In addition, the manager control unit 500 predicts the amount of load during a preset period using a Gaussian process method, based on the past energy consumption. Then, the manager control unit 500 schedules and controls the charging/discharging of the energy storage unit 200 based on information and data such as the predicted PV power, the predicted load, the current PV power, the real-time electric energy charging amount, the real-time load, the real-time temperature, the past energy market price, etc. At this time, the manager control unit 500 can schedule the charging/discharging of the energy storage unit 200 in a variety of forms so that it can be operated in an automatic mode or a manual mode according to a operation state control plan of the manager. For example, the manager control unit 500 can schedule the charging/discharging of the energy storage unit 200 in the automatic mode if the system reliability and stability is intended according to the operation state control plan of the manager, and in the manual mode if the economic feasibility is intended.

Basically, based on the predicted PV power and the predicted load, the manager and the manager control unit 500 controls and manages the PV power stored in the energy storage unit 200, the power supplied from the energy storage unit 200 to the load 400, the power supplied from the external power supplier 300, etc., efficiently in an optimized state.

Specifically, based on the predicted PV power and the predicted load, the manager and the manager control unit 500 controls the battery control part 210 so that the electric energy generated in the power generation unit 100 can be self-consumed in the load 400 as much as possible. In this case, it is preferable to control the battery control part 210 so that only the minimum electric energy of the capacity that is insufficient for the demand of the load 400 can be supplied from the external power supplier 300.

In addition, by referring to the data of the predicted PV power and the predicted load and the past power trading money data, the manager and the manager control unit 500 controls the battery control part 210 so as to increase self-consumption of the electric energy generated in the power generation unit 100 when a predicted power purchase cost is higher than an average purchase cost (or a preset manager-defined standard price). When the predicted power purchase cost is higher than the average purchase cost, the battery part 220 can be discharged with the electric energy as much as possible, thereby increasing the self-consumption while reducing electric energy purchase costs.

On the other hand, by referring to the past power trading money data, the manager and the manager control unit 500 controls the battery control part 210 so as to store electric energy supplied from the external power supplier 300 in the energy storage unit 200 when the predicted power purchase cost is lower than the average purchase cost. Then, the energy storage unit 200 can be discharged with the electric energy as much as possible when a power sale cost is higher than an average sale cost, the battery part 220 can be discharged with the electric energy as much as possible, thereby increasing the profit of electric energy sale, that is, maximizing the profit margin between the power purchase cost and the power sale cost.

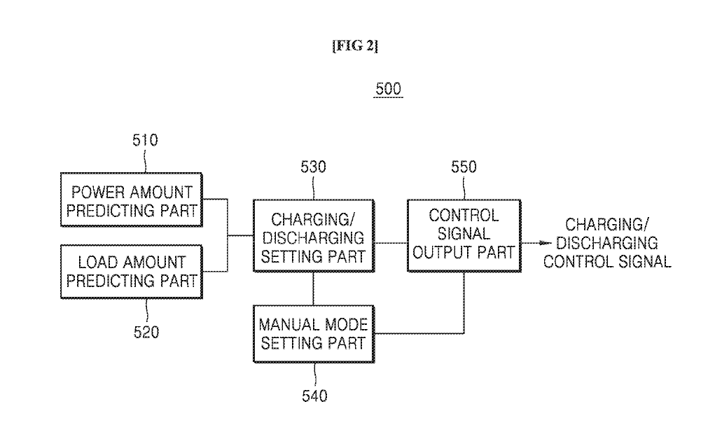

FIG. 2 is a view illustrating the detailed configuration of the manager control unit shown in FIG. 1.

The manager control unit 500 illustrated in FIG. 2 includes a power predicting part 510, a load predicting part 520, a charging/discharging setting part 530, a manual mode setting part 540 and a control signal output part 550.

The power predicting part 510 processes the PV power data during the past predetermined period using a Gaussian process method to predict the amount of PV power generated for a specific period. Specifically, the power predicting part 510 receives the past PV power data for a period (for example, several days to several months) preselected by the manager on a preselected time point (for example, several minutes or several hours) basis. Then, the past PV power data inputted on a preselected period and time point basis are trained according to the Gaussian process method and PV power prediction data for a period preset by the manager are output and then supplied to the charging/discharging setting part 530.

The load predicting part 520 processes the past power consumption data of the load 400, that is, the past load data, using a Gaussian process method to predict the amount of load for a preset period. Similarly, the load predicting part 5:20 receives the past load data for a period (for example, several days to several months) preselected by the manager on a preselected time point (for example, several minutes or several hours) basis. Then, the received past load data are trained according to the Gaussian process method and load prediction data for a period preset by the manager are output and then supplied to the charging/discharging setting part 530.

The charging/discharging setting part 530 schedules and controls the charging/discharging of the energy storage unit 200, based on the predicted PV power and the predicted load, using data such as the current PV power, the current electric energy charging amount, the current load, the current temperature, etc.

Specifically, the charging/discharging setting part 530 receives the PV power prediction data from the power predicting part 510 and the load prediction data from the load predicting part 520. In addition, the charging/discharging setting part 530 receives data such as the current electric energy charging amount, the current load and the current temperature from the manage or a separate database. Thus, the charging/discharging setting part 530 combines the PV power prediction data, the load prediction data and the data such as the current electric energy charging amount, the current load and the current temperature to generate schedule data to be used to schedule the charging/discharging of the energy storage unit 200. In this case, the charging/discharging setting part 530 generates first schedule data in such a form that the charging/discharging of the energy storage unit 200 can be operated in an automatic mode according to an operation state control plan of the manager. In more detail, the charging/discharging setting part 530 establishes a operation state control plan for varying the charging state of the battery part 220 according to a period set by the manager. Then, according to the operation state control plan of the manager, the charging/discharging setting part 530 generates the first schedule data for scheduling the charging/discharging of the energy storage unit 200 in the automatic mode for stabilization.

Meanwhile, the manual mode setting part 540 receive the first schedule data from the charging/discharging setting part 530 and the past power trading money data from the manager or a separate database. Then, the manual mode setting part 540 separately generates second schedule data to be used to schedule the charging/discharging of the energy storage unit 200 in a manual mode for economic feasibility. In this case, the manual mode setting part 540 can generate the second schedule data for scheduling the charging/discharging of the energy storage unit 200 so as to maximize the profit margin between a power purchase cost and a power sale cost by matching the first schedule data and the past power trading money data.

Specifically, the manual mode setting part 540 establishes a control plan for controlling the charging state of the energy storage unit 200 according to a period and a control time point set by the manager so as to maximize the profit margin between the power purchase cost and the power sale cost, and separately generates the second schedule data for controlling the charging/discharging of the energy storage unit 200 according to the control plan established according to the period and the control time point set by the manager.

The control signal output part 550 receives the first and second schedule data from the charging/discharging setting part 530. Then, when the automatic mode is set by the manager, the control signal output part 550 generates a first charging/discharging control signal for controlling the charging/discharging of the energy storage unit 200, based on the first schedule data from the charging/discharging setting part 530, and transmits battery control part 210 of the energy storage unit 200.

On the other hand, when the manual mode is set by the manager, the control signal output part 550 generates a second charging/discharging control signal for controlling the charging/discharging of the energy storage unit 200, based on the second schedule data from the manual mode setting part 540, and transmits it to the battery control part 210 of the energy storage unit 200.

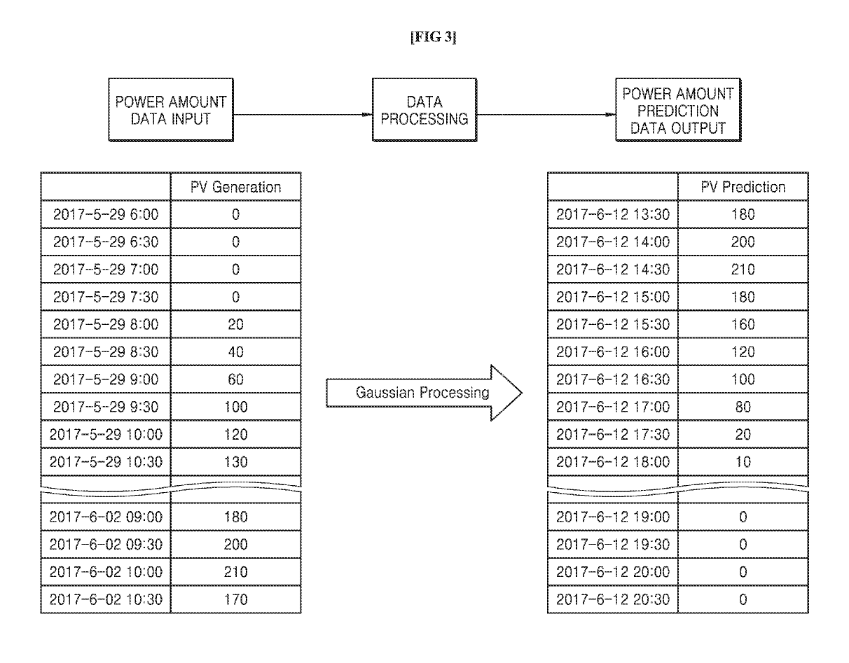

FIG. 3 is a view for explaining a method for predicting the power by the power predicting part shown in FIG. 2.

Referring to FIG. 3, the power predicting part 510 receives the past PV power data for a period preselected by the manager on a preselected time point basis. For example, the power predicting part 510 may receive the PV power data for the past two weeks. In this case, the PV power data for the past two weeks may be received on a half-hour time point basis.

Then, the power predicting part 510 processes the received past PV power data according to the Gaussian process method and outputs the PV power prediction data for a period (e.g., the later 7 hours) preset by the manager.

The Gaussian process method has a merit of applicability and utilization of various simulation tools to various operating systems. The Gaussian process method has another merit that data can be received without a limitation on period and capacity and training is possible even when some of the data are missing. Then, by applying a recent trend to the received data, resultant data can be obtained for a period preset by the manager on a minute/hour/day/month time point basis. Accordingly, the Gaussian process method can be used to easily generate the charging/discharging control signal and segmenting a control time point of the battery control part of the energy storage unit 200.

Thus, by training the past PV power data classified on an optimal time point basis and received for a specific period according to the Gaussian process method, the power predicting part 510 can output the power prediction data correctly considering the recent trend on a preset time point and period basis.

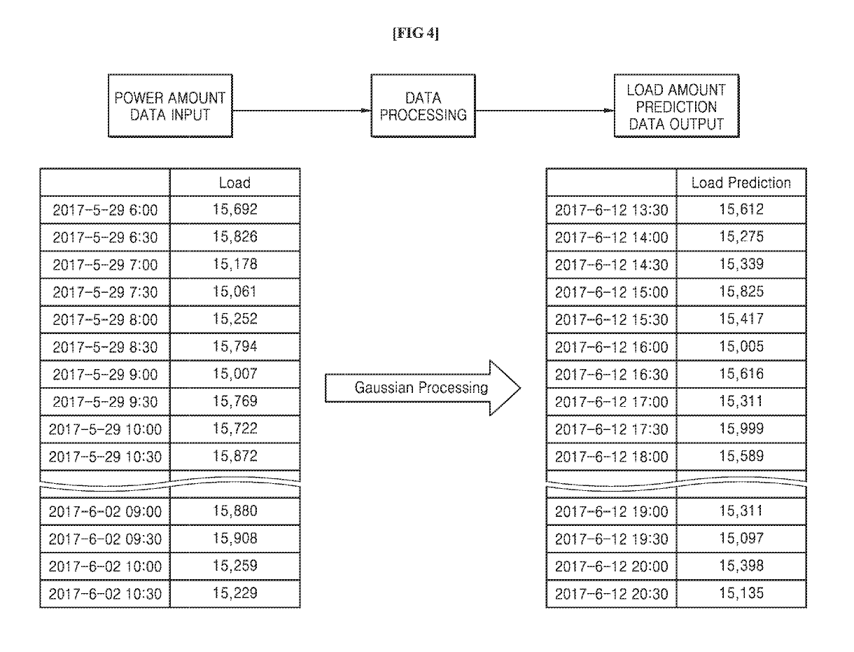

FIG. 4 is a view for explaining a method for predicting the load by the load predicting part shown in FIG. 2.

Referring to FIG. 4, the load predicting part 520 receives the past load data for a period preselected by the manager on a preselected time point basis. For example, the load predicting part 520 may receive the load data for the past two weeks on a half-hour time point basis. Then, the load predicting part 520 processes the received past load data according to the Gaussian process method, thereby resulting in the load prediction data for a period (e.g., the later 7 hours) preset by the manager. The load prediction data is supplied to the charging/discharging setting part 530.

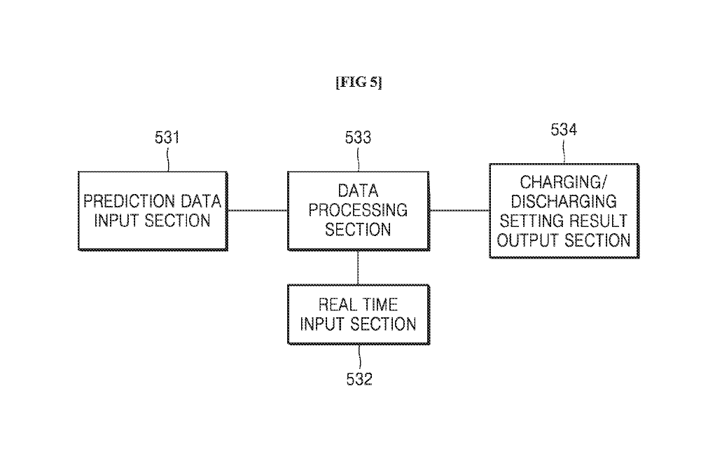

FIG. 5 is a view illustrating the detailed configuration of the charging/discharging setting part shown in FIG. 2.

Referring to FIG. 5, the charging/discharging setting part 530 includes a prediction data input section 531, a current data input section 532, a data processing section 533 and a charging/discharging setting result output section 534.

The prediction data input section 531 receives the power prediction data from the power predicting part 510 and the load prediction data from the load predicting part 520. Then, the prediction data input section 531 transmits the received power prediction data and load prediction data to the data processing section 533, with them matched according to the same period and time point.

The current data input section 532 receives the current PV power data, the current electric energy charging amount data, the current load data and the current temperature data from the manager or the database on a preset period basis. Then, the current data input section 532 transmits the received current PV power data, current electric energy charging amount data, current load data and current temperature data to the data processing section 533, with them matched on a preset period and time point basis.

The data processing section 533 matches the current PV power data, the current electric energy charging amount data, the current load data and the current temperature data with the power prediction data and the load prediction data. Then, the data processing section 533 processes the matched power prediction data, load prediction data, current PV power data, current electric energy charging amount data, current load data and current temperature data according to preset constraint conditions and processing conditions to generate the first schedule data for controlling the storage capacity of the energy storage unit 200.

The constraint conditions preset in the data processing section 533 may include the conditions that the predicted load and the current load should be smaller than the maximum load, the conditions that the capacity for charging supplied from the external power supplier 300 should be smaller than the previously contracted capacity, the conditions that the current load should be smaller than the preset rated capacity, the conditions that the current charging state of the energy storage unit 200 should be maintained between the preset minimum and maximum limited capacities, the conditions that the current temperature of the energy storage unit 200 should be maintained between the preset minimum and maximum limited temperatures, etc.

The first schedule data generation and processing conditions of the data processing section 533 may be defined by the following equations 1 and 2. The first schedule data for controlling the storage capacity of the energy storage unit 200 are generated within a range satisfying the equations 1 and 2.

P_{LOAD(CURRENT)}+P_{TEMPERATURE}=P_{GRID}+P_{BATTERY}+P_{PV(CURRENT)} [Equation 1]

Where, P_{LOAD(CURRENT)} is the current load, P_{TEMPERATURE} is the consumed load of a thermo-hygrostat for controlling the operation temperature of a system facility, P_{GRID} is the capacity for charging/discharging supplied from the external power supplier 300, P_{BATTERY} is the current capacity for charging/discharging in the energy storage unit 200, and P_{PV(CURRENT)} is the current PV power.

Thus, the conditions that data of the sum of loads consumed depending on the effect of the current load and temperature should be equal to data of the sum of the capacity for charging/discharging received from the external power supplier 300, the current capacity for charging/discharging in the energy storage unit 200, and the current battery capacity for charging/discharging have to be satisfied.

P_{LOAD(PREDICTED)}+P_{TEMPERATURE}=P_{GRID}+P_{BATTERY}+P_{PV(PREDICTED)} [Equation 2]

Where, P_{LOAD(PREDICTED)} is the predicted load, P_{TEMPERATURE} is the consumed load of a thermo-hygrostat for controlling the operation temperature of a system facility, P_{GRID} is the capacity for charging/discharging supplied from the external power supplier 300, P_{BATTERY} is the current capacity for charging/discharging in the energy storage unit 200, and P_{PV(PREDICTED)} is the current PV power.

Thus, the conditions that data of the sum of loads consumed depending on the effect of predicted load and temperature should be equal to data of the sum of the capacity for charging/discharging received from the external power supplier 300, the current capacity for charging/discharging in the energy storage unit 200, and the predicted battery capacity for charging/discharging have to be satisfied. When the conditions are satisfied, the first schedule data for controlling the storage capacity of the energy storage unit 200 are sequentially output.

Thereafter, the charging/discharging setting result output section 534 establishes a operation state control plan for varying the charging state of the battery part 220 according to a period set by the manager. Then, according to the operation state control plan, the charging/discharging setting result output section 534 outputs the first schedule data for scheduling the charging/discharging of the energy storage unit 200 according to a specific period and time point.

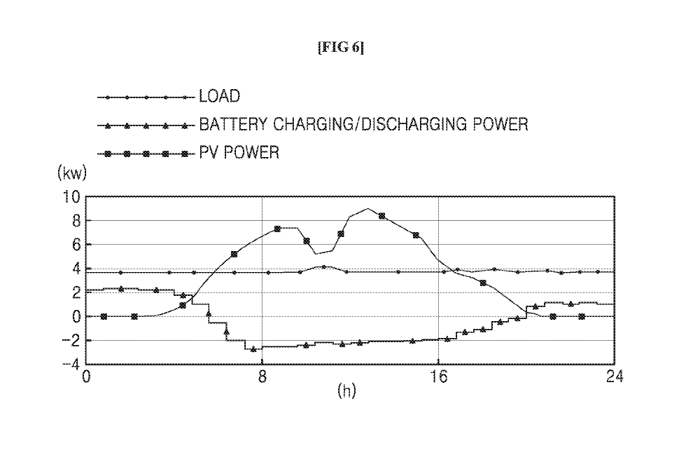

FIG. 6 is a graph illustrating a result of prediction for PV power and load and a corresponding battery usage. FIG. 7 is a graph illustrating a change in cost of power trading with an external power supplier.

As can be seen from the graph in FIG. 6, the manual mode setting part 540 can confirm data on the PV power, the load, the charging/discharging amount of the battery part 220, the charging/discharging state of the battery part 220, etc., from the first schedule data received from the charging/discharging setting part 530.

In addition, the manual mode setting part 540 receives the past power trading money data from the manager or a separate database. The past power trading money data may be represented by the graph as illustrated in FIG. 7.

Thus, the manual mode setting part 540 can separately generate the second schedule data for scheduling the charging/discharging of the energy storage unit 200 so as to maximize the profit margin between a power purchase cost and a power sale cost by matching the first schedule data and the past power trading money data.

Specifically, by referring to the past power trading money data, the manual mode setting part 540 sets a discharging period (e.g., a period from A to B) for which the battery part 220 can be discharged with the electric energy when the power purchase cost is higher than a preset cost. On the other hand, the manual mode setting part 540 sets a charging period (e.g., a period from B to A) for which the battery part 220 can be charged with the electric energy when the power purchase cost is lower than the preset cost.

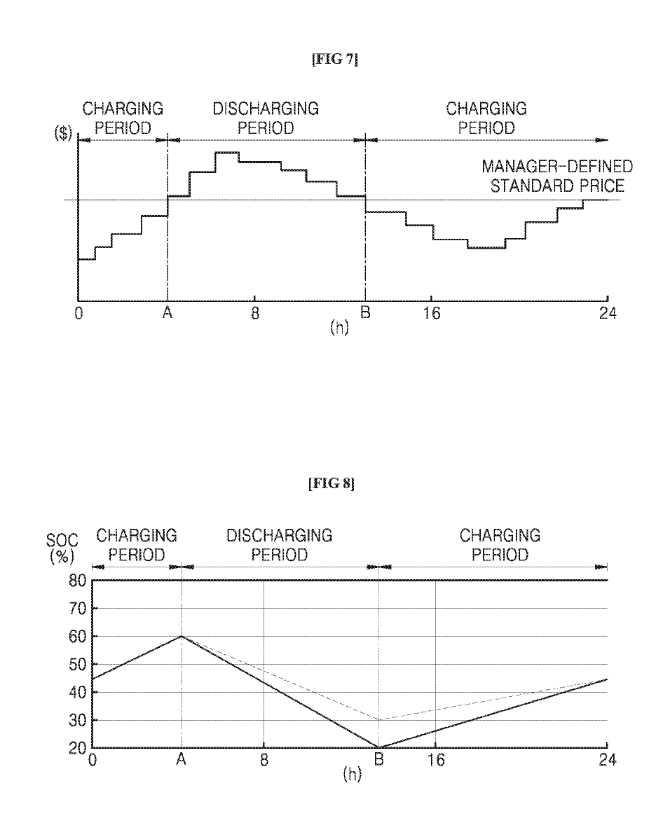

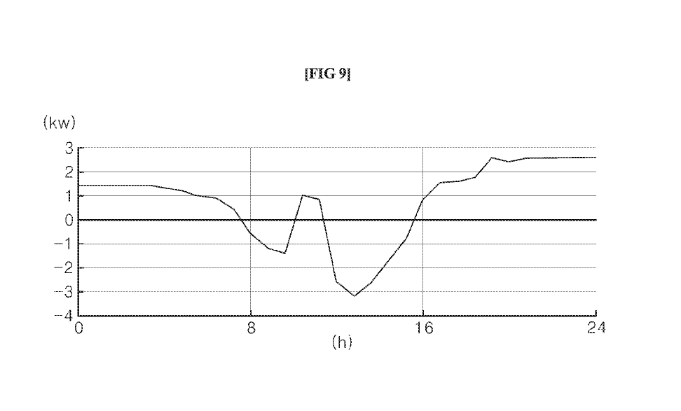

FIG. 8 is a graph illustrating a change in battery charging state which is controlled so as to obtain a profit margin according to a change in PV power/load and power trading cost.

Referring to FIG. 8 in conjunction with FIG. 7, the manual mode setting part 540 establishes a control plan for controlling the charging state of the energy storage unit 200 according to a period and a control time point set by the manager so as to maximize the profit margin between the power purchase cost and the power sale cost, and generates the second schedule data for controlling the charging/discharging of the energy storage unit 200 according to the control plan established according to the period and the control time point set by the manager.

In a period (e.g., a period from A to B) for which the power purchase cost is higher than an average cost or a preset cost, the manual mode setting part 540 generates the second schedule data so as to discharge the battery part 220 of the energy storage unit 200 with the electric energy as much as possible, as illustrated in FIG. 8, that is, to increase self-consumption of generated power. In this case, it is preferable to generate the second schedule data so as to consume the electric energy of the battery part 200 as much as possible, as indicated by a solid line and to provide a higher self-consumption rate than a case of discharging the battery part 200 with only some capacity, as indicated by a dotted line.

On the other hand, in a period (e.g., a period from B to A) for which the power purchase cost is lower than the average cost or the preset cost, the manual mode setting part 540 generates the second schedule data so as to store the electric energy from the external power supplier 300 and the PV generator 120 in the energy storage unit 200 so that the profit margin between the power purchase cost and the power sale cost can be maximized.

FIG. 9 is a graph illustrating a change in power trading which is controlled so as to obtain a profit margin according to a change in PV power/load and power trading cost.

Referring to FIG. 9 in conjunction with FIG. 6, the energy storage unit 200 can set the power charging amount purchased from the external power supplier 300 to be small at the point of time when the PV power is increased, while increasing the power charging amount at the point of time when the PV power is decreased.

Thus, the PV power stored in the energy storage unit 200, the power supplied from the energy storage unit 200 to the load, and the power supplied from the external power supplier 300 can be efficiently controlled and managed according to a result of prediction for the PV power and load.

In particular, as illustrated in FIGS. 6 to 9, it is possible to increase the reliability for the result of prediction by more correctly predicting the PV power and load in consideration of the past trend through a prediction technique using a Gaussian process. In addition, it is possible to stably maintain the optimal operation state by updating the result of prediction for the PV power and load in real time, while scheduling the battery charging/discharging at the present time and for a predetermined period based on the result of prediction.

In addition, it is possible to maximize the self-consumption by concentrating the PV power on the load as much as possible. Thus, it is possible to reduce the power purchase cost incurred to purchase power from the external power supplier based on the past power trading money data and gain a high profit margin at the time of power sale, which can result in improved economic feasibility.

The present disclosure described above may be variously substituted, altered, and modified by those skilled in the art to which the present invention pertains without departing from the scope and sprit of the present disclosure. Therefore, the present disclosure is not limited to the above-mentioned exemplary embodiments and the accompanying drawings.

What is claimed is:

1. A system for managing charging/discharging of electric energy based on prediction for PV power and load, comprising:
a power generation unit configured to generate electric energy from PV power;
a energy storage unit configured to be charged with the electric energy supplied from the power generation unit and electric energy supplied from an external power supplier via one common node or to be discharged with the electric energy to a load via the one common node; and
a manager control unit configured to predict a PV power and a load and schedule and control charging/discharging of the energy storage unit based on data of a result of the prediction.

2. The system according to claim 1, wherein the manager control unit includes:
a power predicting part that predicts the PV power for a preset period by processing the past PV power data using a Gaussian process method;
a load predicting part that predicts the load for the preset period by processing the past load data using the Gaussian process method; and
a charging/discharging setting part that generates first schedule data for scheduling the charging/discharging of the energy storage unit, using at least one information and data of the current PV power, the current electric energy charging amount, the current load and the current temperature, based on the predicted PV power and load.

3. The system according to claim 2, wherein the charging/discharging setting part includes:
a prediction data input section that receives the power prediction data from the power predicting part and the load prediction data from the load predicting part and matches the received power prediction data and load prediction data on a period and time point basis;
a current data input section that receives the current PV power data, the current electric energy charging amount data, the current load data and the current temperature data from a manager or a database on a preset period basis and matches the received current PV power data, current electric energy charging amount data, current load data and current temperature data on a preset period and time point basis;
a data processing section that matches the current PV power data, the current electric energy charging amount data, the current load data and the current temperature data with the power prediction data and the load prediction data and generates and outputs the first schedule data according to the preset constraint conditions and processing conditions; and
a charging/discharging setting result output section that outputs charging/discharging control data for controlling a charging state of the energy storage unit on a preset period and time point basis, based on the first schedule data.

4. The system according to claim 2, wherein the manager control unit further includes a manual mode setting part that generates second schedule data for scheduling the charging/discharging of the energy storage unit so as to maximize a profit margin between a power purchase cost and a power sale cost by matching the first schedule data and the past power trading money data.

5. The system according to claim 4, wherein the manual mode setting part establishes a control plan for controlling the charging state of the energy storage unit according to a period and a control time point set by a manager so as to maximize the profit margin between the power purchase cost and the power sale cost, and generates the second schedule data for controlling the charging/discharging of the energy storage unit according to the control plan established according to the period and the control time point set by the manager.

6. The system according to claim 4, wherein the manager control unit further includes a control signal output part that generates a first charging/discharging control signal for controlling the charging/discharging of the energy storage unit, based on the first schedule data, when an automatic mode is set, and transmits the generated first charging/discharging control signal to the energy storage unit, and that generates a second charging/discharging control signal for controlling the charging/discharging of the energy storage unit, based on the second schedule data, when a manual mode is set, and transmits the generated second charging/discharging control signal to the energy storage unit.
